(19) United States
(12) Patent Application Publication
(10) Pub. No.: US 2002/0164466 A1
(43) Pub. Date: Nov. 7, 2002

(54) Exterior vacuum molded body panels

(76) Inventor: Federico G. Jaekel, Richmond Hill (CA)

Correspondence Address: PILLSBURY WINTHROP, LLP, P.O. BOX 10500, MCLEAN, VA, 22102, US

(21) Appl. No.: 09/931,170

(22) Filed: Aug. 17, 2001

Related U.S. Application Data
(60) Provisional application No. 60/226,094, filed on Aug. 18, 2000.

(51) Int. Cl. B32B 3/00; B32B 9/00; B60N 2/00; B60J 7/00; B60R 27/00; B60K 37/00; B32B 27/14

(52) U.S. Cl. 428/203; 296/191; 428/196

(57) ABSTRACT

Decorative exterior body panels for use on motor vehicles and methods for making the same are presented. Layers of thermoplastic material are sandwiched to produce a laminate. The laminate is then heated and vacuum formed into a selected body panel shape. To further ease the process of production of the vehicle body, the panel may have integral decorative material. Such a panel does not require paint or other extra steps to provide a finished look to the vehicle body. The top layer of the laminate is transparent, allowing the second layer to be seen. The second layer is a decorative material such as fabric or any colored, textured or reflective material.

This application claims the benefit of U.S. Provisional Patent Application Serial No. 60/226,094 filed on Aug. 18, 2000, the contents of which are hereby incorporated herein by reference.

### BACKGROUND OF THE INVENTION

1. Field of the Invention

The present invention relates to vehicular body parts and more specifically, to exterior vacuum molded body panels.

2. Description of Prior Art

Automotive body panels can be broken down generally into two distinct categories, interior and exterior. Traditionally, interior body panels have been made from plastic materials. For example, U.S. Pat. No. 3,867,240 to Doerfling (hereafter the '240 patent) discloses a laminar panel for use in interior trim. The panel of the '240 patent is a contoured thermoplastic resin foam core with a cover sheet and a decorative surface coating covered with an exterior film. The use of plastic for interior body panels is beneficial in that they add to the comfort and feel of the vehicle interior. For example, a textured finish can be provided, such as disclosed in the '240 patent.

Exterior body panels, on the other hand, have traditionally been made from sheet metal. More recently, however, exterior plastic body panels have been introduced in automotive design because of their functional attributes, such as resistance to corrosion, relatively low expense, relatively low weight and resistance to denting. The possible aesthetic advantages of plastic, however, have not heretofore been contemplated with respect to exterior body panels.

### SUMMARY OF THE INVENTION

The present invention provides a strong, cost-effective, decorative exterior body panel for use on automotive vehicles. Layers of thermoplastic material are sandwiched to produce a laminate. The laminate is then heated and vacuum formed into a selected body panel shape. To further ease the process of production of the vehicle body, and to provide an aesthetically pleasing appearance, the panel has an integral decorative material. Such a panel does not require paint or other extra steps to provide a finished look to the vehicle body. Thus, once the body panels are produced, they may simply be fastened to a vehicle frame without further processing.

The invention is particularly useful when the exterior panels disclosed are used in conjunction with a vehicular space frame as disclosed and claimed in Hydroformed Space Frame and Method of Manufacturing the Same, U.S. Pat. No. 6,092,865 and International Application No. WO 99/20516 and which is hereby incorporated by reference in its entirety.

### DESCRIPTION OF THE DRAWINGS

FIG. 1 shows a schematic diagram of a process of making sandwiched, vacuum molded laminates using liquid or powdered plastic material for the top and bottom layers;

FIG. 2 shows a schematic diagram of a process of making sandwiched, vacuum molded laminates using sheets of plastic material for the top and bottom layers;

FIG. 3 shows a side view of a sandwiched, three-layered laminate body panel;

FIG. 4 is a perspective view of a portion of a space frame for a sports utility-type vehicle showing a single body panel in the form of a rear quarter panel constructed according to the teachings of the present invention mounted on one side of the space frame; and

FIG. 5 shows a partial side elevational view of the rear quarter panel mounted on the space frame, portion of which are indicated by dashed lines.

### DETAILED DESCRIPTION OF THE PREFERRED EMBODIMENTS

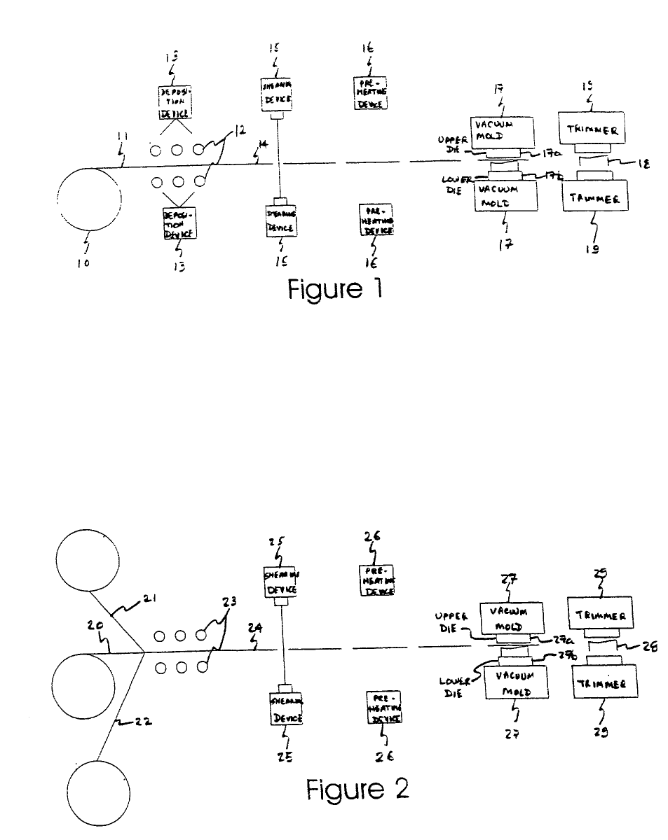

Referring to FIG. 1, a coiled role of decorative material 10 is uncoiled so that a sheet of decorative material 11 passes between an array of rollers 12 and a pair of deposition devices 13. The decorative material may include any of several types of materials. For example, cloth, denim, Lycra or other fabrics may be used. The decorative material may be colored, textured, reflective, or any combination thereof. Fiberglass material may be used, and reinforcement material such as metal or plastic screening may also be used. In addition, the decorative material may have plural (two or more) colors formed thereon, thus creating an aesthetically pleasing pattern. In one contemplated embodiment, the decorative material is a fabric having two or more colors formed thereon. The colors may form a pattern, such as plaid or paisley, for example. If not flexible at room temperature, the decorative material should be flexible at the temperature to which the plastic layers are heated.

Each side of the sheet of decorative material 11 is sprayed with a mixture of liquid or powdered epoxy and plastic by the array of rollers 12 and deposition devices 13, forming a sandwiched, layered plastic material 14. A shearing device 15 cuts the sandwiched, layered plastic material into sheets approximately the size of a finished body panel. The sheets pass through a pre-heating device 16, which may be an open or closed oven, for example, or a pair of heated, opposed platens. The pre-heated, sandwiched, layered plastic sheets enter a vacuum mold 17 and are pressed between an upper die 17a and a lower die 17b. The dies 17a and 17b are then closed, causing each sheet to conform to the mold. The mold draws a vacuum, causing the sheet to conform more closely to the mold and forming molded sheet 18. The molded sheet 18 is removed from the mold and is trimmed by trimmer 19. The molded sheet 18 is then cooled so as to become hard and resilient, and is thereby suitable for use as an exterior body panel.

Referring to FIG. 2, a second method is shown for producing the body panels of the present invention. Rather than using a pair of spray deposition devices 13, the top and bottom layers are in sheet form to begin with. A clear, top layer of epoxy/plastic sheeting 21 and a bottom layer of epoxy/plastic sheeting 22 are sandwiched around a sheet of decorative material 20. After passing through an array of rollers 23, the three sheets together form a sandwiched, layered plastic material 24.

The remaining parts of the second method are similar to that of the first method. That is, a shearing device 25 cuts the sandwiched, layered plastic material into sheets approximately the size of the finished body panel. The sheets pass through a pre-heating device 26, which may be an open or closed oven, for example, or a pair of heated, opposed platens. The pre-heated, sandwiched, layered plastic sheets enter a vacuum mold 27 and are pressed between an upper die 27a and a lower die 27b. The dies 27a and 27b are then closed, causing each sheet to conform to the mold. The mold draws a vacuum, causing the sheet to conform more closely to the mold and forming molded sheet 28. The molded sheet 28 is removed from the mold and is trimmed by trimmer 29. The molded sheet 28 is then cooled so as to become hard and resilient, and is thereby suitable for use as an exterior body panel.

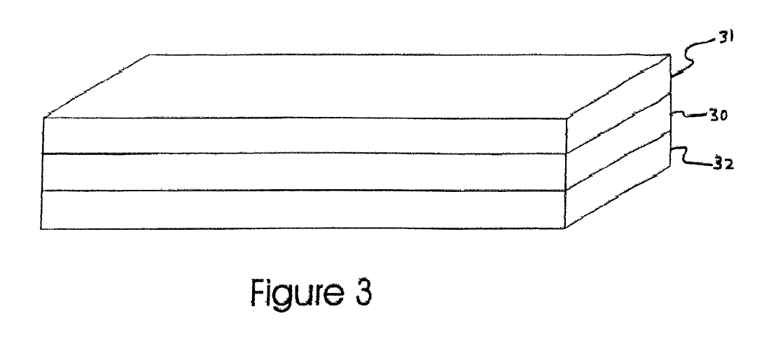

Referring now to FIG. 3, a section of the molded sheet is shown. In particular, the molded sheet includes a layer of decorative material 30 (e.g., formed by decorative material 11 in the first embodiment or by decorative material 20 in the second embodiment) sandwiched between a plastic inner layer 31 that is to face the vehicle frame, and an outer layer 32 that faces away from the vehicle frame. The plastic outer layer 32 should be substantially transparent to reveal the texture and color of the decorative material 30. The inner layer 31 and outer layer 32 can be formed by the spray method illustrated in FIG. 1 or the sheeting method illustrated in FIG. 2.

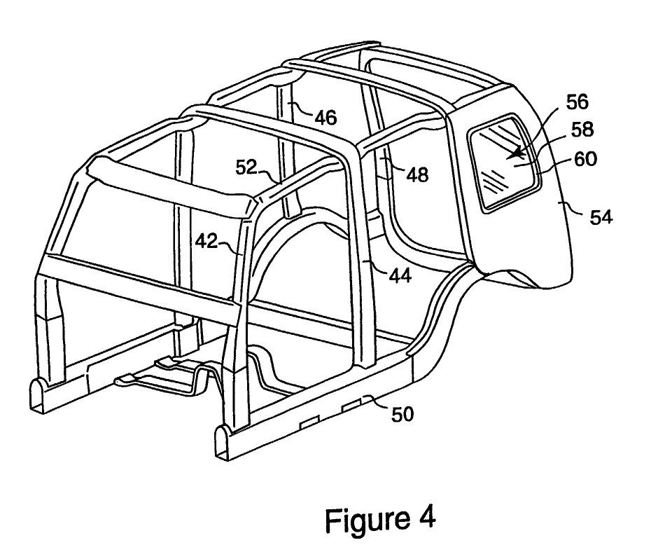

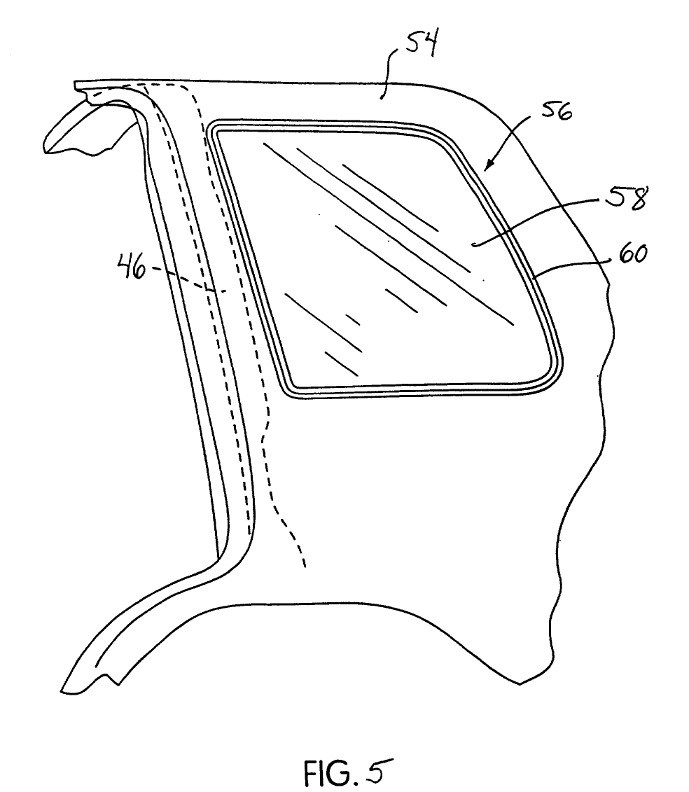

FIG. 4 shows a portion of a hydroformed space frame generally designated 40 for constructing a sports utility-type motor vehicle. The construction of the space frame 40, including the manner in which the individual hydroformed members are formed and the manner in which the individual hydroformed members are interconnected to form the space frame 40, is disclosed and described in detail in the above incorporated U.S. Pat. No. 6,092,865 and International Application No. WO 99/20516 and is not considered in depth in the present application. The interconnected hydroformed members provide an A pillar 42, a B pillar 44, a C pillar 46 and a D pillar 48 on each side of the space frame 40. Each pillar 42, 44, 46, 48 is connected at one end to a hydroformed lower side rail 50. A roof rail 52 extends integrally rearwardly from the A pillar 42 and is connected to upper end portions of the B, C and D pillars 44, 46, 48.

Suitably shaped exterior vehicle body panels constructed according to the principles of present invention can be advantageously mounted on the hydroformed space frame 40 of this type during vehicle assembly to form the exterior of the sports utility vehicle. FIGS. 4 and 5 illustrate the manner in which a single exemplary molded plastic sheet 54 in the form of a rear quarter panel is mounted on the space frame 40. Preferably, the rear quarter panel 54 would be fixed to adjacent portions of the space frame 40, including the C pillar 46, the D pillar 48, a rearward portion of the side rail member 50 and the rearward portion of the longitudinally extending roof rail 52, by a structural adhesive. A central opening 56 is formed in the quarter panel 54 to accommodate installation of a transparent panel 58 constructed of polycarbonate such as Plexiglas® or the like to provide a rear side widow. A rubber-like continuous seal 60 disposed around the perimeter of the opening 56 insulates and helps support the transparent panel 58.

It can be understood that the views of FIGS. 4 and 5 showing a single body panel 54 mounted on the frame 40 are intended to illustrate a use of a plastic panel constructed according to the teachings of the invention only and are not intended to imply any limitations or preferences on the order in which vehicle components are assembled to one another during vehicle manufacture.

While it will be apparent to one of ordinary skill in the art that the descriptions of the preferred embodiments are meant to achieve the advantages and benefits of the present invention, it will be appreciated that the invention is susceptible to modification and variation without departing from the spirit thereof.

What is claimed is:

1. A method of producing an exterior body panel for use on automotive vehicles, comprising:
providing a decorative layer;
forming a laminate by providing a thermoplastic material on a top side and on a bottom side of the decorative layer, at least one of the top side and bottom side being substantially transparent;
heating the laminate;
conforming the laminate into a desired shape;
cooling the laminate.

2. The method as set forth in claim 1, wherein the decorative layer is flexible.

3. The method as set forth in claim 1, wherein the laminate is pressed in vacuum molding die machine comprising an upper die and a lower die.

4. The method as set forth in claim 3, wherein a vacuum conforms the laminate to one of the upper die and the lower die.

5. A method of making vacuum formed exterior body panels, comprising:
providing a layer of decorative material;
depositing one side of the decorative material a mixture of epoxy and resin which when cured forms a plastic layer that is substantially transparent;
depositing on an opposite side of the decorative material a mixture of epoxy and resin which when cured forms a plastic layer;
heating the decorative material and the plastic layers;
pressing the decorative material, the top plastic layer and the bottom plastic layer in a vacuum mold to form a laminate; and
cooling the pressed laminate.

6. The method as set forth in claim 5, wherein the layer of decorative material is flexible.

7. The method as set forth in claim 5, wherein the vacuum mold comprises an upper die and a lower die.

8. The method as set forth in claim 5, further comprising removing air from the vacuum mold in forming the molded laminate.

9. An exterior body panel for use on automotive vehicles, comprising:
a substantially transparent outer layer;
an inner layer; and
a decorative layer sandwiched between the outer layer and the inner layer.

10. The exterior body panel of claim 9, wherein the decorative material is flexible.

11. The exterior body panel of claim 10, wherein said decorative layer is selected from a group including fabric, wire mesh, plastic screening, colored plastic and fiberglass.
